(19) United States
(12) Patent Application Publication
(10) Pub. No.: US 2017/0016559 A1
(43) Pub. Date: Jan. 19, 2017

(54) GAS CONNECTOR ASSEMBLY

(71) Applicant: Chiu-Chih Chung, Changhua (TW)

(72) Inventor: Chiu-Chih Chung, Changhua (TW)

(21) Appl. No.: 14/800,568

(22) Filed: Jul. 15, 2015

(51) Int. Cl. F16L 15/08; F16L 21/02; F16L 21/08; F16L 15/04

(52) U.S. Cl. CPC F16L 15/08; F16L 15/04; F16L 21/02; F16L 21/08

(57) ABSTRACT

A gas connector assembly is disclosed and comprises a first pipe member and a second pipe member. The first cap is covered at top of the first pipe body. Part of the male connection section is rotatably inserted into the first pipe body. The first balls are arranged between the first pipe body and the first cap and limited by the male connection section. Top of the second pipe body is fluidly communicated with bottom of the first pipe body. A first obtuse angle is included between the first and second pipe bodies. The second cap is covered at bottom of the second pipe body. The female connection section is rotatably inserted into the second pipe body. The second balls are arranged between the second pipe body and the second cap and limited by the female connection section.

### FIELD OF THE INVENTION

The present invention relates to a connector, and more particularly to a gas connector assembly.

### BACKGROUND OF THE INVENTION

Commercial gas fired appliances, such as fryers, ranges and stoves, used in restaurants and other commercial and institutional kitchens, must be moved frequently to permit cleaning beneath and behind them as well as for enabling maintenance, repairs and inspections. Such appliances can weigh several hundred pounds and are equipped with casters to facilitate movement.

Connectors for delivering gas to commercial gas fired appliances have been constructed to permit movement without disconnecting the gas supply lines. One proposal was to construct the connector from lengths of rigid pipe connected together by relatively rotatable sealed swivel joints so that the pipe assembly was flexed and straightened and the appliance moved toward and away from its normal operating location.

Even though the pipe assemblies were capable of flexure during appliance movements the assemblies rigidly resisted movements in certain directions. When appliances turned during movement, bending and wrenching moments were exerted on the pipes and the swivel joints.

Please reference to U.S. Pat. No. 5,553,893. In order to improve above drawback, a connector for delivering combustion gas to a gas fired appliance from a stationary supply line where the appliance moves toward and away from the supply line with the connector straightening and flexing between them as the appliance moves. The connector comprises a flexible hose assembly and first and second swivel fittings at respective hose assembly ends. Each swivel fitting defines a gas flow path and comprises a swivel member for communicating the connector with the appliance or the supply line. The hose assembly comprises a flexible metal hose member antitorsion fittings forming ends of the hose assembly connected to respective swivel fittings. The antitorsion fittings comprise pintle and nipple members rotatable relative to each other to prevent torsional stress in the hose member when the appliance moves relative to the supply line.

However, the structure is complicated and the operation is inconvenient. Furthermore, it has only one rotating direction and easy to result in gas leakage after the hose is twisted many times.

Accordingly, the inventor of the present invention has devoted himself based on his many years of practical experiences to solve this problem.

### SUMMARY OF THE INVENTION

The primary object of the present invention is to provide a gas connector assembly. When in use, the male connection section of the first pipe member of the first sect of the gas connector assembly may screwed and fluidly communicated with a gas outlet, and the female connection section of the second pipe member may be fluidly communicated with a connection pipe. Female connection section of the second pipe member of the second set of the gas connector assembly may be fluidly communicated the other end of the connection pipe opposite to the first set of the gas connector assembly, and the male connection section of the first pipe member may be screwed and fluidly communicated with a gas inlet. The male connection section may be rotatably inserted into the first pipe body and the female connection section may be rotatably inserted into the second pipe body due to the arrangement of the first balls and the second balls. As a result, when a machine having the gas inlet is moving, two ends of the connection pipe may prevent from broken and damage to result in gas leakage and industrial safety accident.

In order to achieve the above object, the gas connector assembly of the present invention may comprise a first pipe member, having a first pipe body, a male connection section, a first cap, and a plurality of first balls, the first cap is covered on a top end of the of the first pipe body, part of the male connection section is passing through the first cap and then inserted into the first pipe body, each of the first balls is arranged between the top end of the first pipe body and an inner top surface of the first cap so that the first balls are limited by the part of the male connection section inserted into the first pipe body and the male connection section is rotatably inserted into the first pipe body; and a second pipe member, having a second pipe body, a female connection section, a second cap, and a plurality of second balls, a top end of the second pipe body is fluidly communicated with a bottom end of the first pipe body opposite to the top end thereof, a first obtuse angle is included between an axis of the second pipe body and an axis of the first pipe body, the second cap is covered at a bottom end of the second pipe body opposite to the top end thereof, part of the female connection section is passing through the second cap and then inserted into the second pipe body, each of the second balls is arranged between the bottom end of the second pipe body and an inner bottom surface of the second cap so that the second balls are limited by the part of the female connection section inserted into the second pipe body and the female connection section is rotatably inserted into the second pipe body.

In some embodiments, the male connection section includes a first ring groove portion, a first outer convex ring portion, and a male screwing portion, two ends of the first outer convex ring portion are respectively fluidly communicated with the first ring groove portion and the male screwing portion, an outer diameter of the first outer convex ring portion is larger than an outer diameter of the first ring groove portion and an outer diameter of the male screwing portion, the first ring groove portion is inserted into the first pipe body, at least one first limit ring groove is formed at an outer surface of the first ring groove portion and arranged corresponding to the first balls for receiving and limiting the first balls, and the female connection section includes a second ring groove portion, a second outer convex ring portion, and a female screwing portion, two ends of the second outer convex ring portion are respectively fluidly communicated with the second ring groove portion and the female screwing portion, an outer diameter of the second outer convex ring portion is larger than an outer diameter of the second ring groove portion and an outer diameter of the female screwing portion, the second ring groove portion is inserted into the second pipe body, at least one second limit ring groove is formed at an outer surface of the second ring groove portion and arranged corresponding to the second balls for receiving and limiting the second balls, a second obtuse angle is included between an axis of the second outer convex ring portion and an axis of the second screwing portion.

In some embodiments, a first outer sealing ring is interposed between the first outer convex ring portion and an outer top surface of the first cap, a first inner shoulder is formed at the top end of the first pipe body, a first limit sealing ring is covered the first ring groove portion corresponding to the first inner shoulder, the first limit sealing ring is limited at the first inner shoulder, a top end of the first limit sealing ring is against each of the first balls, at least one first concave ring groove is formed at one end of the first ring groove portion opposite to the first outer convex ring portion for providing a first inner sealing ring to be covered, and two sides of the first inner sealing ring are respectively pressed tightly by the first concave ring groove and an inner surface of the first pipe body, and a second outer sealing ring is interposed between the second outer convex ring portion and an outer bottom surface of the second cap, a second inner shoulder is formed at the bottom end of the second pipe body, a second limit sealing ring is covered the second ring groove portion corresponding to the second inner shoulder, the second limit sealing ring is limited at the second inner shoulder, a bottom end of the second limit sealing ring is against each of the second balls, at least one second concave ring groove is formed at one end of the second ring groove portion corresponding to the second outer convex ring portion for providing an inner sealing ring to be covered, and two sides of the second inner sealing ring are respectively pressed tightly by the second concave ring groove and an inner surface of the second pipe body.

In some embodiments, the first cap is screwed at the top end of the first pipe body, and the second cap is screwed at the bottom end of the second pipe body.

In some embodiments, at least one first bolt is passing through a first outer side wall and then against an outer surface of the first pipe body so that the first cap is fastened outside of the first pipe body, and at least one second bolt is passing through a second outer side wall of the second cap and then against an outer surface of the second pipe body so that the second cap is fastened outside of the second pipe body.

Further features and advantages of the present invention will become apparent to those of skill in the art in view of the detailed description of preferred embodiments which follows, when considered together with the attached drawings and claims.

### BRIEF DESCRIPTION OF THE DRAWINGS

All the objects, advantages, and novel features of the invention will become more apparent from the following detailed descriptions when taken in conjunction with the accompanying drawings.

FIG. 1 is an exploded view of a gas connector assembly according to present invention.

FIG. 2 is a schematic view of the gas connector assembly according to present invention.

FIG. 3 is a cross-sectional view of the gas connector assembly according to present invention.

FIG. 4 is a top view of the gas connector assembly according to present invention while rotating.

FIG. 5 is a side view of the gas connector assembly according to present invention while rotating.

FIG. 6 is a view of the gas connector assembly according to present invention while in use.

### DESCRIPTION OF THE PREFERRED EMBODIMENT

Referring now to the drawings where like characteristics and features among the various figures are denoted by like reference characters.

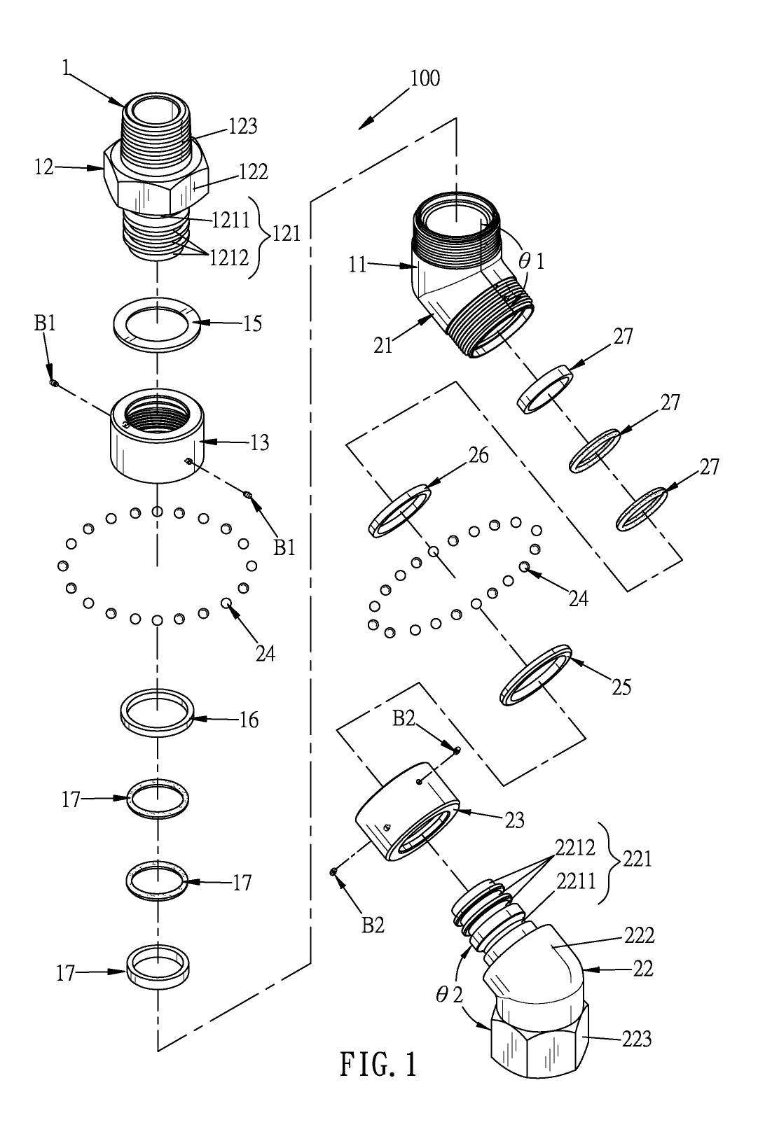

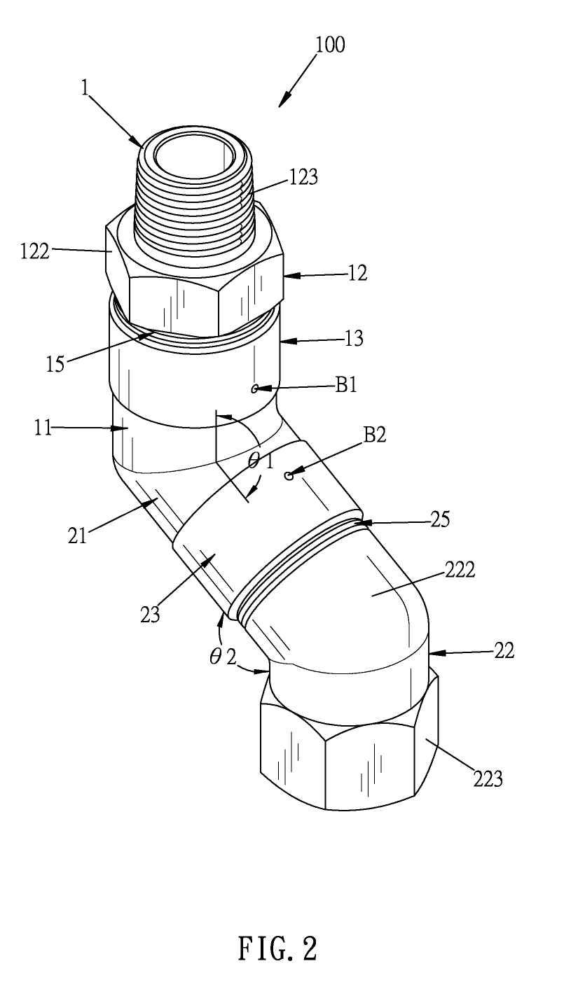

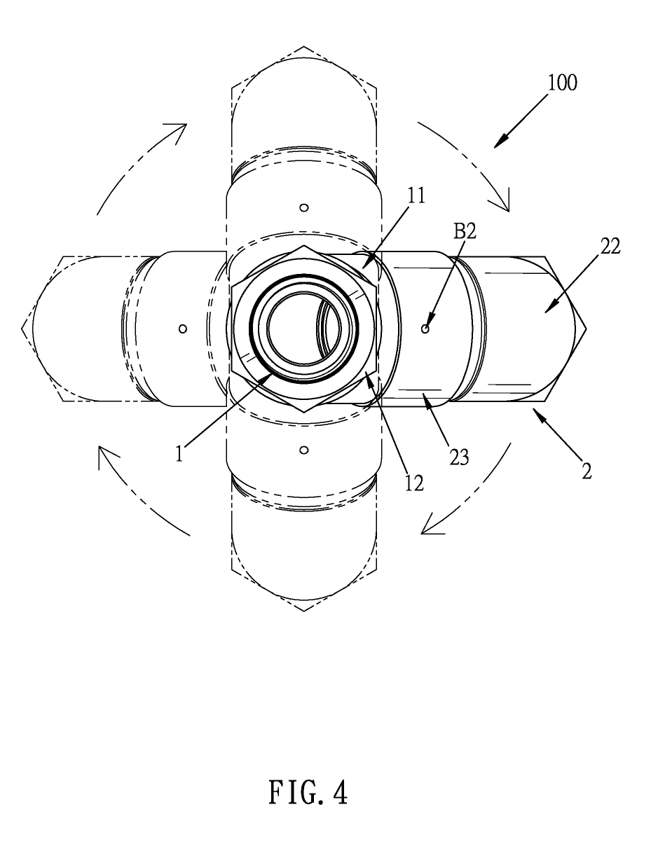

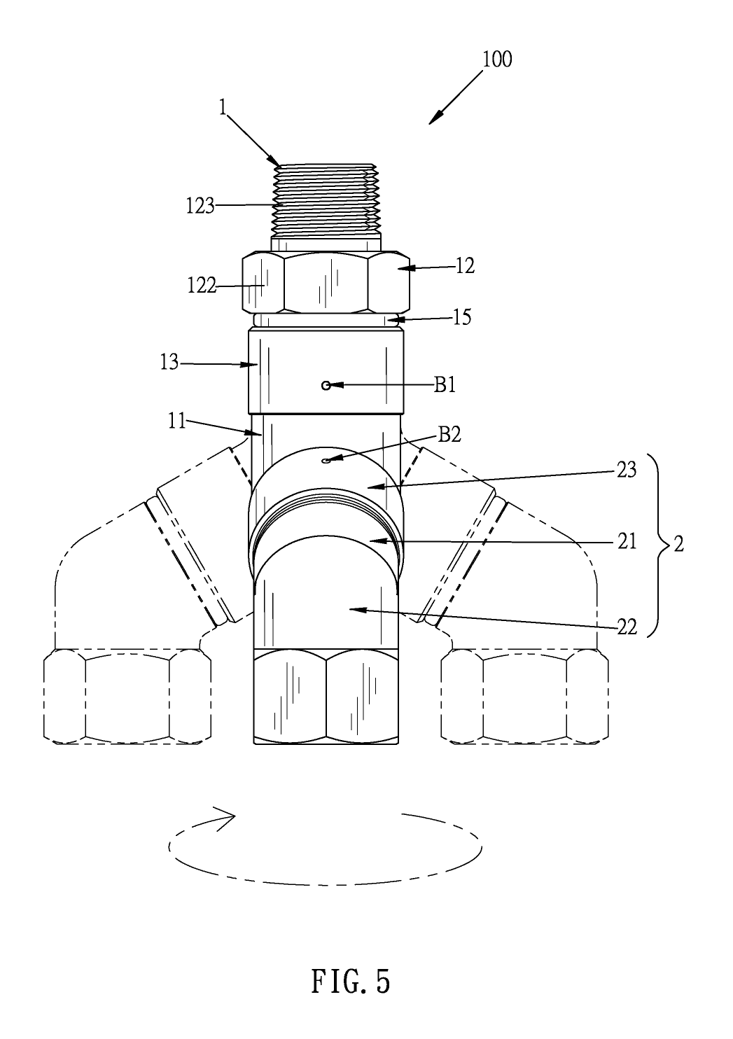

Please refer to FIGS. 1 to 6, a gas connector assembly 100 of the present invention comprises a first pipe member and a second pipe member 2.

The first pipe member 1 may have a first pipe body 11, a male connection section 12, a first cap 13, and a plurality of first balls 14. The first cap 13 is covered on a top end of the of the first pipe body 11. Part of the male connection section 12 (that is the first ring groove portion 121) is passing through the first cap 13 and then inserted into the first pipe body 11. Each of the first balls 14 is arranged between the top end of the first pipe body 11 and an inner top surface of the first cap 13 so that the first balls 14 are limited by the part of the male connection section 12 inserted into the first pipe body 11 and the male connection section 12 may be rotatably inserted into the first pipe body 11.

The male connection section 12 includes a first ring groove portion 121, a first outer convex ring portion 122, and a male screwing portion 123. Two ends of the first outer convex ring portion 122 are respectively fluidly communicated with the first ring groove portion 121 and the male screwing portion 123. An outer diameter of the first outer convex ring portion 122 is larger than an outer diameter of the first ring groove portion 121 and an outer diameter of the male screwing portion 123. The first ring groove portion 121 is inserted into the first pipe body 11. At least one first limit ring groove 1211 is formed at an outer surface of the first ring groove portion 121 and arranged corresponding to the first balls 14 for receiving and limiting the first balls 14.

A first outer sealing ring 15 may be interposed between the first outer convex ring portion 122 and an outer top surface of the first cap 13. A first inner shoulder 111 may be formed at the top end of the first pipe body 11. A first limit sealing ring 16 may be covered the first ring groove portion 121 corresponding to the first inner shoulder 111. The first limit sealing ring 16 is limited at the first inner shoulder 111. A top end of the first limit sealing ring 16 is against each of the first balls 14. At least one first concave ring groove 1212 (three for illustration, but not limited thereto) may be formed at one end of the first ring groove portion 121 opposite to the first outer convex ring portion 122 for providing a first inner sealing ring 17 to be covered, and two sides of the first inner sealing ring 17 are respectively pressed tightly by the first concave ring groove 1212 and an inner surface of the first pipe body 11. Therefore, the gap formed among the first pipe body 11, the male connection section 12, and the first cap 13 may be totally sealed by the arrangement of the first outer sealing ring 15, the first limit sealing ring 16, and the first inner sealing ring 17 so as to prevent gas from leakage.

The second pipe member 2 may have a second pipe body 21, a female connection section 22, a second cap 23, and a plurality of second balls 24. A top end of the second pipe body 21 may be fluidly communicated with a bottom end of the first pipe body 11 opposite to the top end thereof. A first obtuse angle θ1 is included between an axis of the second pipe body 21 and an axis of the first pipe body 11. The second cap 23 may be covered at a bottom end of the second pipe body 21 opposite to the top end thereof. Part of the female connection section 22 (that is the second ring groove 221) may be passing through the second cap 23 and then inserted into the second pipe body 21. Each of the second balls 24 may be arranged between the bottom end of the second pipe body 21 and an inner bottom surface of the second cap 23 so that the second balls 24 may be limited by the part of the female connection section 22 inserted into the second pipe body 21(that is the second ring groove 221) and the female connection section 22 may be rotatably inserted into the second pipe body 21.

The female connection section 22 may include a second ring groove portion 221, a second outer convex ring portion 222, and a female screwing portion 223. Two ends of the second outer convex ring portion 222 are respectively fluidly communicated with the second ring groove portion 221 and the female screwing portion 223. An outer diameter of the second outer convex ring portion 222 is larger than an outer diameter of the second ring groove portion 221 and an outer diameter of the female screwing portion 223. The second ring groove portion 221 is inserted into the second pipe body 21. At least one second limit ring groove 2211 is formed at an outer surface of the second ring groove portion 221 and arranged corresponding to the second balls 24 for receiving and limiting the second balls 24. A second obtuse angle θ2 is included between an axis of the second outer convex ring portion 222 and an axis of the male screwing portion 223.

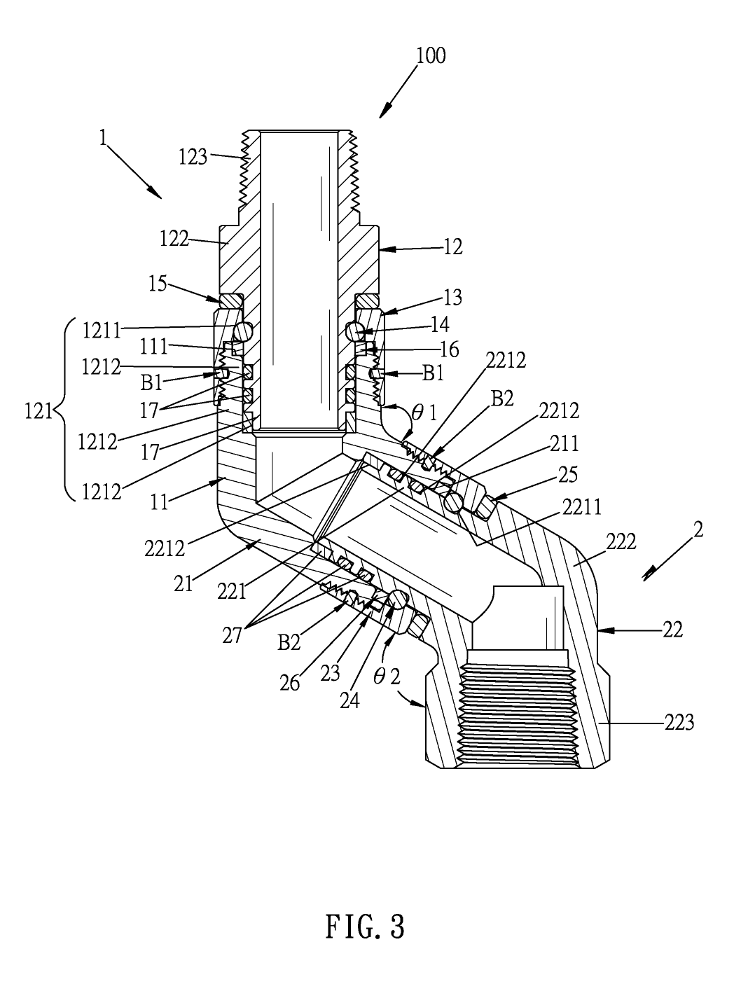

Please refer to FIG. 3, the first obtuse angle θ1 included between the first pipe body 11 and the second pipe body is located at right side, and the second obtuse angle θ2 included between the second outer convex ring portion 222 and the male screwing portion 223 is located at left side. Therefore, in one embodiment, the axis of the first pipe body 11 is parallel to the axis of the male screwing portion 223.

A second outer sealing ring 25 may be interposed between the second outer convex ring portion 222 and an outer bottom surface of the second cap 23. A second inner shoulder 211 may be formed at the bottom end of the second pipe body 21. A second limit sealing ring 26 may be covered the second ring groove portion 221 corresponding to the second inner shoulder 211. The second limit sealing ring 26 may be limited at the second inner shoulder 211. A bottom end of the second limit sealing ring 26 may be against each of the second balls 24. At least one second concave ring groove 2212 may be formed at one end of the second ring groove portion 221 corresponding to the second outer convex ring portion 222 for providing an inner sealing ring 27 to be covered. And two sides of second inner sealing ring 27 are respectively pressed tightly by the second concave ring groove 2212 and an inner surface of the second pipe body 21. Therefore, the gap formed among the second pipe body 21, the female connection section 22, and the second cap 23 is totally sealed by the arrangement of the second outer sealing ring 25, the second limit sealing ring 26, and the second inner sealing ring 27 so as to prevent the gas from leakage.

The first cap 13 may be screwed at the top end of the first pipe body 11, and the second cap 23 may be screwed at the bottom end of the second pipe body 21. Preferably, at least one first bolt B1 (two first bolts arranged opposite to each other for illustration, but not limit thereto) may be passing through a first outer side wall of the first cap 13 and then against an outer surface of the first pipe body 11 so that the first cap 13 may be fastened outside of the first pipe body 11. At least one second bolts (two second bolts arranged opposite to each other for illustration, but not limited thereto) may be passing through a second outer side wall of the second cap 23 so that the second cap 23 may be fastened outside of the second pipe body 21.

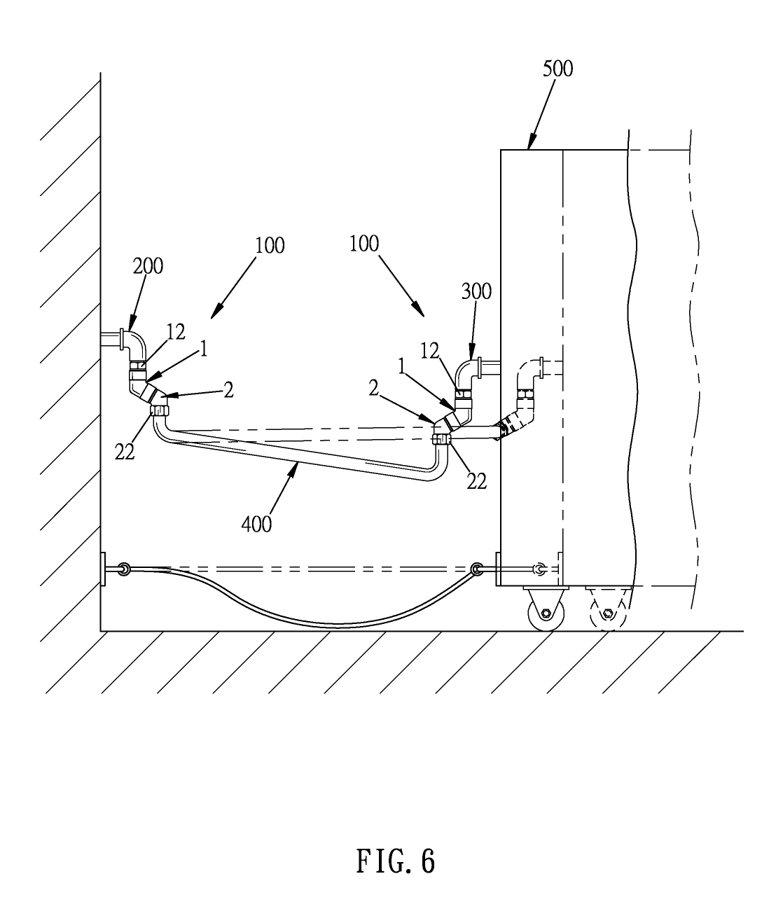

When in use shown as in FIG. 6, the male connection section 12 of the first pipe member 1 of the first sect of the gas connector assembly 100 (left side of the FIG. 6) may screwed and fluidly communicated with a gas outlet 200, and the female connection section 22 of the second pipe member 2 may be fluidly communicated with a connection pipe 400. Female connection section 22 of the second pipe member 2 of the second set of the gas connector assembly 100 (right side of FIG. 6) may be fluidly communicated the other end of the connection pipe 400 opposite to the first set of the gas connector assembly 100, and the male connection section 12 of the first pipe member 1 may be screwed and fluidly communicated with a gas inlet 300. The male connection section 12 may be rotatably inserted into the first pipe body 11 and the female connection section 22 may be rotatably inserted into the second pipe body 21 due to the arrangement of the first balls 14 and the second balls 24. As a result, when a machine 500 having the gas inlet 300 is moving, two ends of the connection pipe 400 may prevent from broken and damage to result in gas leakage and industrial safety accident.

The foregoing descriptions are merely the exemplified embodiments of the present invention, where the scope of the claim of the present invention is not intended to be limited by the embodiments. Any equivalent embodiments or modifications without departing from the spirit and scope of the present invention are therefore intended to be embraced.

The disclosed structure of the invention has not appeared in the prior art and features efficacy better than the prior structure which is construed to be a novel and creative invention, thereby filing the present application herein subject to the patent law.

What is claimed is:

1. A gas connector assembly, comprising:
a first pipe member, having a first pipe body, a male connection section, a first cap, and a plurality of first balls, the first cap is covered on a top end of the of the first pipe body, part of the male connection section is passing through the first cap and then inserted into the first pipe body, each of the first balls is arranged between the top end of the first pipe body and an inner top surface of the first cap so that the first balls are limited by the part of the male connection section inserted into the first pipe body and the male connection section is rotatably inserted into the first pipe body; and
a second pipe member, having a second pipe body, a female connection section, a second cap, and a plurality of second balls, a top end of the second pipe body is fluidly communicated with a bottom end of the first pipe body opposite to the top end thereof, a first obtuse angle is included between an axis of the second pipe body and an axis of the first pipe body, the second cap is covered at a bottom end of the second pipe body opposite to the top end thereof, part of the female connection section is passing through the second cap and then inserted into the second pipe body, each of the second balls is arranged between the bottom end of the second pipe body and an inner bottom surface of the second cap so that the second balls are limited by the part of the female connection section inserted into the second pipe body and the female connection section is rotatably inserted into the second pipe body.

2. The gas connector assembly as claimed in claim 1, wherein the male connection section includes a first ring groove portion, a first outer convex ring portion, and a male screwing portion, two ends of the first outer convex ring portion are respectively fluidly communicated with the first ring groove portion and the male screwing portion, an outer diameter of the first outer convex ring portion is larger than an outer diameter of the first ring groove portion and an outer diameter of the male screwing portion, the first ring groove portion is inserted into the first pipe body, at least one first limit ring groove is formed at an outer surface of the first ring groove portion and arranged corresponding to the first balls for receiving and limiting the first balls.

3. The gas connector assembly as claimed in claim 1, wherein the female connection section includes a second ring groove portion, a second outer convex ring portion, and a female screwing portion, two ends of the second outer convex ring portion are respectively fluidly communicated with the second ring groove portion and the female screwing portion, an outer diameter of the second outer convex ring portion is larger than an outer diameter of the second ring groove portion and an outer diameter of the female screwing portion, the second ring groove portion is inserted into the second pipe body, at least one second limit ring groove is formed at an outer surface of the second ring groove portion and arranged corresponding to the second balls for receiving and limiting the second balls, a second obtuse angle is included between an axis of the second outer convex ring portion and an axis of the second screwing portion.

4. The gas connector assembly as claimed in claim 1, wherein the male connection section includes a first ring groove portion, a first outer convex ring portion, and a male screwing portion, two ends of the first outer convex ring portion are respectively fluidly communicated with the first ring groove portion and the male screwing portion, an outer diameter of the first outer convex ring portion is larger than an outer diameter of the first ring groove portion and an outer diameter of the male screwing portion, the first ring groove portion is inserted into the first pipe body, at least one first limit ring groove is formed at an outer surface of the first ring groove portion and arranged corresponding to the first balls for receiving and limiting the first balls, and the female connection section includes a second ring groove portion, a second outer convex ring portion, and a female screwing portion, two ends of the second outer convex ring portion are respectively fluidly communicated with the second ring groove portion and the female screwing portion, an outer diameter of the second outer convex ring portion is larger than an outer diameter of the second ring groove portion and an outer diameter of the female screwing portion, the second ring groove portion is inserted into the second pipe body, at least one second limit ring groove is formed at an outer surface of the second ring groove portion and arranged corresponding to the second balls for receiving and limiting the second balls, a second obtuse angle is included between an axis of the second pipe body and an axis of the first pipe body.

5. The gas connector assembly as claimed in claim 2, wherein a first outer sealing ring is interposed between the first outer convex ring portion and an outer top surface of the first cap, a first inner shoulder is formed at the top end of the first pipe body, a first limit sealing ring is covered the first ring groove portion corresponding to the first inner shoulder, the first limit sealing ring is limited at the first inner shoulder, a top end of the first limit sealing ring is against each of the first balls, at least one first concave ring groove is formed at one end of the first ring groove portion opposite to the first outer convex ring portion for providing a first inner sealing ring to be covered, and two sides of the first inner sealing ring are respectively pressed tightly by the first concave ring groove and an inner surface of the first pipe body.

6. The gas connector assembly as claimed in claim 3, wherein a second outer sealing ring is interposed between the second outer convex ring portion and an outer bottom surface of the second cap, a second inner shoulder is formed at the bottom end of the second pipe body, a second limit sealing ring is covered the second ring groove portion corresponding to the second inner shoulder, the second limit sealing ring is limited at the second inner shoulder, a bottom end of the second limit sealing ring is against each of the second balls, at least one second concave ring groove is formed at one end of the second ring groove portion corresponding to the second outer convex ring portion for providing an inner sealing ring to be covered, and two sides of the second inner sealing ring are respectively pressed tightly by the second concave ring groove and an inner surface of the second pipe body.

7. The gas connector assembly as claimed in claim 4, wherein a first outer sealing ring is interposed between the first outer convex ring portion and an outer top surface of the first cap, a first inner shoulder is formed at the top end of the first pipe body, a first limit sealing ring is covered the first ring groove portion corresponding to the first inner shoulder, the first limit sealing ring is limited at the first inner shoulder, a top end of the first limit sealing ring is against each of the first balls, at least one first concave ring groove is formed at one end of the first ring groove portion opposite to the first outer convex ring portion for providing a first inner sealing ring to be covered, and two sides of the first inner sealing ring are respectively pressed tightly by the first concave ring groove and an inner surface of the first pipe body, and a second outer sealing ring is interposed between the second outer convex ring portion and an outer bottom surface of the second cap, a second inner shoulder is formed at the bottom end of the second pipe body, a second limit sealing ring is covered the second ring groove portion corresponding to the second inner shoulder, the second limit sealing ring is limited at the second inner shoulder, a bottom end of the second limit sealing ring is against each of the second balls, at least one second concave ring groove is formed at one end of the second ring groove portion corresponding to the second outer convex ring portion for providing an inner sealing ring to be covered, and the second inner sealing ring is respectively pressed tightly by the second concave ring groove and an inner surface of the second pipe body.

8. The gas connector assembly as claimed in claim 1, wherein the first cap is screwed at the top end of the first pipe body, and the second cap is screwed at the bottom end of the second pipe body.

9. The gas connector assembly as claimed in claim 1, wherein at least one first bolt is passing through a first outer side wall and then against an outer surface of the first pipe body so that the first cap is fastened outside of the first pipe body, and at least one second bolt is passing through a second outer side wall of the second cap and then against an outer surface of the second pipe body so that the second cap is fastened outside of the second pipe body.

10. The gas connector assembly as claimed in claim 8, wherein at least one first bolt is passing through a first outer side wall and then against an outer surface of the first pipe body so that the first cap is fastened outside of the first pipe body, and at least one second bolt is passing through a second outer side wall of the second cap and then against an outer surface of the second pipe body so that the second cap is fastened outside of the second pipe body.
